(19) United States
(12) Patent Application Publication
(10) Pub. No.: US 2004/0186978 A1
(43) Pub. Date: Sep. 23, 2004

(54) High-speed single chip microcomputer

(75) Inventors: Yi-Feng Jang, Hsin-Chu (TW); Chih Hung Tseng, Hsin-Chu (TW)

Correspondence Address: SQUIRE, SANDERS & DEMPSEY L.L.P, 600 HANSEN WAY, PALO ALTO, CA, 94304-1043, US

(73) Assignee: WELTREND SEMICONDUCTOR, INC., Hsin-Chu (TW)

(21) Appl. No.: 10/439,498

(22) Filed: May 15, 2003

(30) Foreign Application Priority Data
Feb. 24, 2003 (TW) 092103817

(51) Int. Cl. G06F 15/00

(52) U.S. Cl. 712/1

(57) ABSTRACT

A high-speed single chip microcomputer compatible with an Intel 8-bits single chip microcomputer, that comprises the feature of: a machine cycle of the high-speed single chip microcomputer containing three state cycles, and the instruction execution time being equal to triple multiple of the state cycle.

### FIELD OF THE INVENTION

The present invention is related to a high-speed single chip microcomputer that is compatible with the Intel 8051 single chip microcomputer. By regulating a machine cycle of the single chip microcomputer to only contain three state cycles, we can speed up the instruction execution of the single chip microcomputer.

### BACKGROUND OF THE INVENTION

The single chip microcomputer is an integrated chip (IC) that integrates a microcomputer into a single chip. It is at least comprised of a central processing unit (CPU), a memory unit, and an I/O unit. Due to the integrated microcomputer architecture, it is easy to develop an electrical product by using the single chip microcomputer. For example, the applications include music cards, remote controllers, communication devices, and even industrial controllers, etc.

The single chip microcomputer 8051, that belongs to MCS-51 series and designed by Intel, is one of the most popular and generally used 8-bits single chip microcomputers in the current market. So, many IC Design Houses and manufacturers also produce 8051 compatible single chip microcomputers. For example, 89C51 of ATMEL is fully compatible with Intel 8051.

The single chip microcomputers of Intel's MCS-51 series, including 8051, have been development for a long time since 1980. For now, the functions of the IA products and the industrial controller are more and more complex, so we need a more powerful single chip microcomputer to meet the requirements of these applications. And the most effective method is to speed up the instruction execution of the single chip microcomputer.

In the prior art, a machine cycle of 8051 contains six state cycles, and the time length of the state cycle is equal to two clock cycles of CPU clock. Therefore, the time length of a machine cycle is equal to 12 clock cycles. It takes 8051 single chip microcomputer 1 to 4 machine cycles for executing an instruction. That is equal to twelve multiple of the clock cycle.

### SUMMARY OF THE INVENTION

The main purpose of the present invention is, developing a high-speed single chip microcomputer that is compatible with Intel 8051 to improve the instruction execution speed. By regulating a machine cycle of the single chip microcomputer to only contain three state cycles, and the time length of a state cycle being equal to a clock cycle of CPU Clock, the instruction execution time of the single chip microcomputer will become only triple multiple of the clock cycle. Then we can speed up the instruction execution of the single chip microcomputer.

For above purpose, the present invention provides a kind of high-speed single chip microcomputer, that is compatible with an Intel 8-bits single chip microcomputer and comprises the feature of: a machine cycle of the single chip microcomputer containing three state cycles, and the execution time of an instruction being equal to triple multiple of the state cycle.

In accordance with one aspect of the present invention, the Intel 8-bits single chip microcomputer belongs to MCS-51 series.

In accordance with one aspect of the present invention, the single chip microcomputer of MCS-51 series is 8051.

In accordance with one aspect of the present invention, the time length of said state cycle is equal to a clock cycle of CPU clock.

In accordance with one aspect of the present invention, the single chip microcomputer is embedded into a controller.

The present invention may best be understood through the following description with reference to the accompanying drawings, in which:

### BRIEF DESCRIPTION OF THE DRAWINGS

FIG. 1: The execution sequence diagram of a one-byte instruction containing three clock cycles.

FIG. 2: The execution sequence diagram of a one-byte instruction containing six clock cycles.

FIG. 3: The execution sequence diagram of a two-bytes instruction containing six clock cycles.

### DETAILED DESCRIPTION OF THE PREFERRED EMBODIMENT

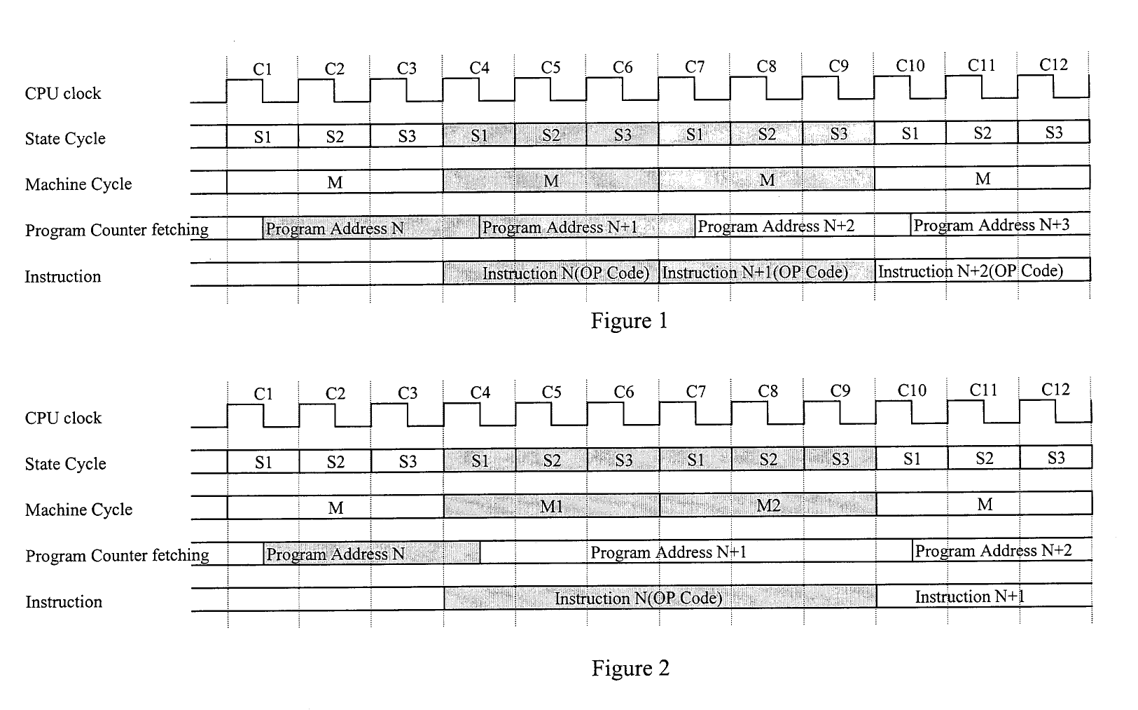

FIG. 1 is a preferred embodiment according to the present invention. That is the execution sequence diagram of a one-byte instruction containing three clock cycles. The time length of a state cycle is equal to a clock cycle of CPU clock. The execution sequence of the instruction is:

Clock cycle C1 (state cycle S1): The program counter fetches the data at the program address N from the program memory.

Clock cycle C2 (state cycle S2): The fetched data appears in the data bus.

Clock cycle C3 (state cycle S3): Instruction N is a one-byte OP code, which is decoded by CPU.

Clock cycle C4˜C6 (state cycle S1˜S3, machine cycle M): The execution cycle of Instruction N is equal to three clock cycles, that is, three state cycles are equal to one machine cycle. Instruction N+1 is also contained in this cycle, fetched from the program address N+1 of the program memory, and decoded by CPU.

Clock cycle C7˜C9 (state cycle S1˜S3, machine cycle M): The execution cycle of Instruction N+1 is also three state cycles, which is equal to one machine cycle. Instruction N+2 is also contained in this cycle, fetched from the program address N+2 of the program memory, and decoded by CPU.

Clock cycle C10˜C2 (state cycle S1˜S3, machine Cycle M): The execution cycle of Instruction N+2 is also three state cycles, which is equal to one machine cycle. In this cycle, program counter will fetch data from program address N+2 of the program memory.

FIG. 2 is the other preferred embodiment according to the present invention. That is the execution sequence diagram of a one-byte instruction containing six clock cycles. The time length of a state cycle is equal to a clock cycle of CPU clock. The execution sequence of the instruction is:

Clock cycle C1 (state cycle S1): The program counter fetches the data at the program address N from the program memory.

Clock cycle C2 (state cycle S2): The fetched data appears in the Data Bus.

Clock cycle C3 (state cycle S3): Instruction N is a one-byte OP Code, which is decoded by CPU.

Clock cycle C4˜C9 (state cycle S1˜S3 will be progresses twice, machine cycle M1˜M2): The execution cycle of Instruction N is equal to six clock cycles, that is, six state cycles are equal to two machine cycles. Instruction N+1 is also contained in this cycle, fetched from the program address N+1 of the program memory, and decoded by CPU.

Clock cycle C10˜C12 (state cycle S1˜S3): The execution cycle duration of Instruction N+1. During this cycle, program counter will fetch data from program address N+2 of the program memory.

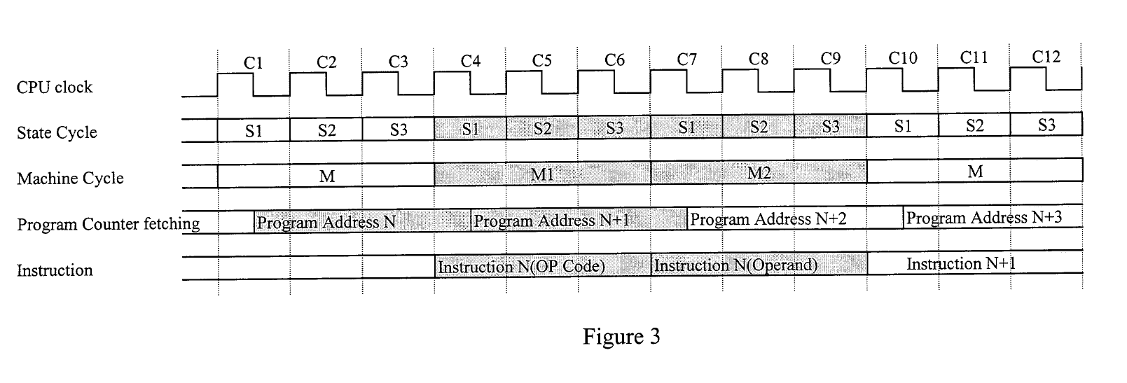

FIG. 3 is another preferred embodiment according to the present invention. That is the execution sequence diagram of a two-bytes instruction containing six clock cycles. The time length of a state cycle is equal to a clock cycle of CPU clock. The execution sequence of the instruction is:

Clock cycle C1 (state cycle S1): The program counter fetches the data at the program address N from the program memory.

Clock cycle C2 (state cycle S2): The fetched data appears in the Data Bus.

Clock cycle C3 (state cycle S3): Instruction N is a one-byte OP Code, which is decoded by CPU.

Clock cycle C4˜C6 (state cycle S1˜S3, machine cycle M1): The program counter fetches the data at the program address N+1 from the program memory, and sends to CPU as the Operand of Instruction N for instruction execution.

Clock cycle C7˜C9 (state cycle S1˜S3, machine cycle M2): Processing the execution of Instruction N, and the duration is three clock cycles. That is, three state cycles are equal to one machine cycle. Therefore, the total execution cycle of Instruction N is six clock cycles within the Operand fetching of Instruction N to CPU; that is six state cycles or two machine cycles. During this cycle, the program counter will fetch data from program address N+2 of program memory.

The above preferred embodiments illustrate the execution sequence of three 8051 standard instructions. In fact, we have completed the hardware design of the present invention to implement a high-speed 8051 compatible single chip microcomputer, and all standard instructions of 8051 and extending instructions of 8051 compatible single chip microcomputers are also well executed on it.

Attachment 1 shows the comparison table of the instruction execution speed between the prior Intel 8051 and high-speed 8051 compatible single chip microcomputer (WT8051T) of the present invention, that is all based on the same CPU clock. In the table, the instruction execution time of WT8051T is equal to triple multiple of three clock cycles, that is the triple multiple of state cycle; but the standard Intel 8051 will be the twelve multiple. From Attachment 1 we may easily find that, the instruction execution speed of WT8051T will be faster than standard Intel 8051 for 2.88 times averagely.

To sum up, the present invention provides an improving solution for the prior art. By regulating a machine cycle of the single chip microcomputer that is compatible with Intel 8051 to only contain three state cycles, and the time length of a state cycle being equal to a clock cycle of CPU Clock, we can make the instruction execution time of the single chip microcomputer become only triple multiple of the clock cycle. The improvement of the present invention is, based on the instruction execution speed comparison of the prior Intel 8051 and the high-speed 8051 compatible single chip microcomputer of the present invention, the instruction execution speed of the present invention will be faster than the prior Intel 8051 for 2.88 times averagely. It is obvious to speed up the instruction execution of the single chip microcomputer.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims that are to be accorded with the broadest interpretation so as to encompass all such modifications and similar structures.

Attachment 1: The instruction execution speed comparison table of the prior Intel 8051 and the high-speed 8051 compatible single chip microcomputer of the present invention.

Attachment 1

| | | | Winbond | Standard | WT8051T |
|---|---|---|---|---|---|
| | | | Turbo | Intel 8051 | vs Intel |
| | Hexa-deci | | 8051 Clock | Clock | 8051 Speed |
| Instruction | Op-code | Byte | Cycles | Cycles | Ratio |
| NOP | 0 | 1 | 3 | 12 | 4 |
| ADD A, R0 | 28 | 1 | 3 | 12 | 4 |
| ADD A, R1 | 29 | 1 | 3 | 12 | 4 |
| ADD A, R2 | 2A | 1 | 3 | 12 | 4 |
| ADD A, R3 | 2B | 1 | 3 | 12 | 4 |
| ADD A, R4 | 2C | 1 | 3 | 12 | 4 |
| ADD A, R5 | 2D | 1 | 3 | 12 | 4 |
| ADD A, R6 | 2E | 1 | 3 | 12 | 4 |
| ADD A, R7 | 2F | 1 | 3 | 12 | 4 |
| ADD A, @R0 | 26 | 1 | 6 | 12 | 2 |
| ADD A, @R1 | 27 | 1 | 6 | 12 | 2 |
| ADD A, direct | 25 | 2 | 6 | 12 | 2 |
| ADD A, #data | 24 | 2 | 6 | 12 | 2 |
| ADDC A, R0 | 38 | 1 | 3 | 12 | 4 |
| ADDC A, R1 | 39 | 1 | 3 | 12 | 4 |
| ADDC A, R2 | 3A | 1 | 3 | 12 | 4 |
| ADDC A, R3 | 3B | 1 | 3 | 12 | 4 |
| ADDC A, R4 | 3C | 1 | 3 | 12 | 4 |
| ADDC A, R5 | 3D | 1 | 3 | 12 | 4 |
| ADDC A, R6 | 3E | 1 | 3 | 12 | 4 |
| ADDC A, R7 | 3F | 1 | 3 | 12 | 4 |
| ADDC A, @R0 | 36 | 1 | 6 | 12 | 2 |
| ADDC A, @R1 | 37 | 1 | 6 | 12 | 2 |
| ADDC A, direct | 35 | 2 | 6 | 12 | 2 |
| ADDC A, #data | 34 | 2 | 6 | 12 | 2 |
| ACALL addr11 | 11, 31, 51, 71, | 2 | 12 | 24 | 2 |
| | 91, B1, D1, F1 | | | | |
| AJMP addr11 | 01, 21, 41, 61, | 2 | 12 | 24 | 2 |
| | 81, A1, C1, E1 | | | | |
| ANL A, R0 | 58 | 1 | 3 | 12 | 4 |
| ANL A, R1 | 59 | 1 | 3 | 12 | 4 |
| ANL A, R2 | 5A | 1 | 3 | 12 | 4 |
| ANL A, R3 | 5B | 1 | 3 | 12 | 4 |
| ANL A, R4 | 5C | 1 | 3 | 12 | 4 |
| ANL A, R5 | 5D | 1 | 3 | 12 | 4 |
| ANL A, R6 | 5E | 1 | 3 | 12 | 4 |
| ANL A, R7 | 5F | 1 | 3 | 12 | 4 |
| ANL A, @R0 | 56 | 1 | 6 | 12 | 2 |
| ANL A, @R1 | 57 | 1 | 6 | 12 | 2 |
| ANL A, direct | 55 | 2 | 6 | 12 | 2 |
| ANL A, #data | 54 | 2 | 6 | 12 | 2 |
| ANL direct, A | 52 | 2 | 6 | 12 | 2 |
| ANL direct, #data | 53 | 3 | 12 | 24 | 2 |
| ANL C, bit | 82 | 2 | 12 | 24 | 2 |
| ANL C, /bit | BO | 2 | 12 | 24 | 2 |
| CJNE A, direct, rel | B5 | 3 | 12 | 24 | 2 |
| CJNE A, #data, rel | B4 | 3 | 12 | 24 | 2 |
| CJNE @R0, #data, rel | B6 | 3 | 12 | 24 | 2 |
| CJNE @R1, #data, rel | B7 | 3 | 12 | 24 | 2 |
| CJNE R0, #data, rel | B8 | 3 | 12 | 24 | 2 |
| CJNE R1, #data, rel | B9 | 3 | 12 | 24 | 2 |
| CJNE R2, #data, rel | BA | 3 | 12 | 24 | 2 |
| CJNE R3, #data, rel | BB | 3 | 12 | 24 | 2 |
| CJNE R4, #data, rel | BC | 3 | 12 | 24 | 2 |
| CJNE R5, #data, rel | BD | 3 | 12 | 24 | 2 |
| CJNE R6, #data, rel | BE | 3 | 12 | 24 | 2 |
| CJNE R7, #data, rel | BE | 3 | 12 | 24 | 2 |
| CLR A | E4 | 1 | 3 | 12 | 4 |
| CPL A | F4 | 1 | 3 | 12 | 4 |
| CLR C | C3 | 1 | 3 | 12 | 4 |
| CLR bit | C2 | 2 | 6 | 12 | 2 |
| CPL C | B3 | 1 | 3 | 12 | 4 |
| CPL bit | B2 | 2 | 6 | 12 | 2 |
| DEC A | 14 | 1 | 3 | 12 | 4 |
| DEC R0 | 18 | 1 | 3 | 12 | 4 |
| DEC R1 | 19 | 1 | 3 | 12 | 4 |
| DEC R2 | 1A | 1 | 3 | 12 | 4 |
| DEC R3 | 1B | 1 | 3 | 12 | 4 |
| DEC R4 | 1C | 1 | 3 | 12 | 4 |
| DEC R5 | 1D | 1 | 3 | 12 | 4 |
| DEC R6 | 1E | 1 | 3 | 12 | 4 |
| DEC R7 | 1F | 1 | 3 | 12 | 4 |
| DEC @R0 | 16 | 1 | 6 | 12 | 2 |
| DEC @R1 | 17 | 1 | 6 | 12 | 2 |
| DEC direct | 15 | 2 | 6 | 12 | 2 |
| DEC DPTR | A5 | — | — | — | — |
| DIV AB | 84 | 1 | 24 | 48 | 2 |
| DA A | D4 | 1 | 6 | 12 | 2 |
| DJNZ R0, rel | D8 | 2 | 12 | 24 | 2 |
| DJNZ R1, rel | D9 | 2 | 12 | 24 | 2 |
| DJNZ R2, rel | DD | 2 | 12 | 24 | 2 |
| DJNZ R3, rel | DA | 2 | 12 | 24 | 2 |
| DJNZ R4, rel | DB | 2 | 12 | 24 | 2 |
| DJNZ R5, rel | DC | 2 | 12 | 24 | 2 |
| DJNZ R6, rel | DE | 2 | 12 | 24 | 2 |
| DJNZ R7, rel | DF | 2 | 12 | 24 | 2 |
| DJNZ direct, rel | D5 | 3 | 12 | 24 | 2 |
| INC A | 04 | 1 | 3 | 12 | 4 |
| INC R0 | 08 | 1 | 3 | 12 | 4 |
| INC R1 | 09 | 1 | 3 | 12 | 4 |
| INC R2 | 0A | 1 | 3 | 12 | 4 |
| INC R3 | 0B | 1 | 3 | 12 | 4 |
| INC R4 | 0C | 1 | 3 | 12 | 4 |
| INC R5 | 0D | 1 | 3 | 12 | 4 |
| INC R6 | 0E | 1 | 3 | 12 | 4 |
| INC R7 | 0F | 1 | 3 | 12 | 4 |
| INC @R0 | 06 | 1 | 6 | 12 | 2 |
| INC @R1 | 07 | 1 | 6 | 12 | 2 |
| INC direct | 05 | 2 | 6 | 12 | 2 |
| INC DPTR | A3 | 1 | 12 | 24 | 2 |
| JMP @A+DPTR | 73 | 1 | 12 | 24 | 2 |
| JZ rel | 60 | 2 | 12 | 24 | 2 |
| JNZ rel | 70 | 2 | 12 | 24 | 2 |
| JC rel | 40 | 2 | 12 | 24 | 2 |
| JNC rel | 50 | 2 | 12 | 24 | 2 |
| JB bit, rel | 20 | 3 | 12 | 24 | 2 |
| JNB bit, rel | 30 | 3 | 12 | 24 | 2 |
| JBC bit, rel | 10 | 3 | 12 | 24 | 2 |
| LCALL addr16 | 12 | 3 | 12 | 24 | 2 |
| LJMP addr16 | 02 | 3 | 12 | 24 | 2 |
| MUL AB | A4 | 1 | 24 | 48 | 2 |
| MOV A, R0 | E8 | 1 | 3 | 12 | 4 |
| MOV A, R1 | E9 | 1 | 3 | 12 | 4 |
| MOV A, R2 | EA | 1 | 3 | 12 | 4 |
| MOV A, R3 | EB | 1 | 3 | 12 | 4 |
| MOV A, R4 | EC | 1 | 3 | 12 | 4 |
| MOV A, R5 | ED | 1 | 3 | 12 | 4 |
| MOV A, R6 | EE | 1 | 3 | 12 | 4 |
| MOV A, R7 | EF | 1 | 3 | 12 | 4 |
| MOV A, @R0 | E6 | 1 | 3 | 12 | 4 |
| MOV A, @R1 | E7 | 1 | 3 | 12 | 4 |
| MOV A, direct | E5 | 2 | 6 | 12 | 2 |
| MOV A, #data | 74 | 2 | 6 | 12 | 2 |
| MOV R0, A | F8 | 1 | 3 | 12 | 4 |
| MOV R1, A | F9 | 1 | 3 | 12 | 4 |
| MOV R2, A | FA | 1 | 3 | 12 | 4 |
| MOV R3, A | FB | 1 | 3 | 12 | 4 |
| MOV R4, A | FC | 1 | 3 | 12 | 4 |
| MOV R5, A | FD | 1 | 3 | 12 | 4 |
| MOV R6, A | FE | 1 | 3 | 12 | 4 |
| MOV R7, A | FF | 1 | 3 | 12 | 4 |
| MOV R0, direct | A8 | 2 | 6 | 12 | 2 |
| MOV R1, direct | A9 | 2 | 6 | 12 | 2 |
| MOV R2, direct | AA | 2 | 6 | 12 | 2 |
| MOV R3, direct | AB | 2 | 6 | 12 | 2 |
| MOV R4, direct | AC | 2 | 6 | 12 | 2 |
| MOV R5, direct | AD | 2 | 6 | 12 | 2 |
| MOV R6, direct | AE | 2 | 6 | 12 | 2 |
| MOV R7, direct | AF | 2 | 6 | 12 | 2 |
| MOV R0, #data | 78 | 2 | 6 | 12 | 2 |
| MOV R1, #data | 79 | 2 | 6 | 12 | 2 |
| MOV R2, #data | 7A | 2 | 6 | 12 | 2 |
| MOV R3, #data | 7B | 2 | 6 | 12 | 2 |
| MOV R4, #data | 7C | 2 | 6 | 12 | 2 |
| MOV R5, #data | 7D | 2 | 6 | 12 | 2 |
| MOV R6, #data | 7E | 2 | 6 | 12 | 2 |
| MOV R7, #data | 7F | 2 | 6 | 12 | 2 |
| MOV @R0, A | F6 | 1 | 3 | 12 | 4 |
| MOV @R1, A | F7 | 1 | 3 | 12 | 4 |
| MOV @R0, direct | A6 | 2 | 6 | 12 | 2 |
| MOV @R1, direct | A7 | 2 | 6 | 12 | 2 |
| MOV @R0, #data | 76 | 2 | 6 | 12 | 2 |
| MOV @R1, #data | 77 | 2 | 6 | 12 | 2 |
| MOV direct, A | F5 | 2 | 12 | 24 | 2 |
| MOV direct, R0 | 88 | 2 | 12 | 24 | 2 |
| MOV direct, R1 | 89 | 2 | 12 | 24 | 2 |
| MOV direct, R2 | 8A | 2 | 12 | 24 | 2 |
| MOV direct, R3 | 8B | 2 | 12 | 24 | 2 |
| MOV direct, R4 | 8C | 2 | 12 | 24 | 2 |
| MOV direct, R5 | 8D | 2 | 12 | 24 | 2 |
| MOV direct, R6 | 8E | 2 | 12 | 24 | 2 |
| MOV direct, R7 | 8F | 2 | 12 | 24 | 2 |
| MOV direct, @R0 | 86 | 2 | 12 | 24 | 2 |
| MOV direct, @R1 | 87 | 2 | 12 | 24 | 2 |
| MOV direct, direct | 85 | 3 | 12 | 24 | 2 |
| MOV direct, #data | 75 | 3 | 12 | 24 | 2 |
| MOV DPTR, #data 16 | 90 | 3 | 12 | 24 | 2 |
| MOVC A, @A+DPTR | 93 | 1 | 12 | 24 | 2 |
| MOVC A, @A+PC | 83 | 1 | 12 | 24 | 2 |
| MOVX A, @R0 | E2 | 1 | 12-96_{(default 12)} | 24 | 2 |
| MOVX A, @R1 | E3 | 1 | 12-96_{(default 12)} | 24 | 2 |
| MOVX A, @DPTR | E0 | 1 | 12-96_{(default 12)} | 24 | 2 |
| MOVX @R0, A | F2 | 1 | 12-96_{(default 12)} | 24 | 2 |
| MOVX @R1, A | F3 | 1 | 12-96_{(default 12)} | 24 | 2 |
| MOVX @DPTR, A | F0 | 1 | 12-96_{(default 12)} | 24 | 2 |
| MOV C, bit | A2 | 2 | 6 | 12 | 2 |
| MOV bit, C | 92 | 2 | 12 | 24 | 2 |
| ORL A, R0 | 48 | 1 | 3 | 12 | 4 |
| ORL A, R1 | 49 | 1 | 3 | 12 | 4 |
| ORL A, R2 | 4A | 1 | 3 | 12 | 4 |
| ORL A, R3 | 4B | 1 | 3 | 12 | 4 |
| ORL A, R4 | 4C | 1 | 3 | 12 | 4 |
| ORL A, R5 | 4D | 1 | 3 | 12 | 4 |
| ORL A, R6 | 4E | 1 | 3 | 12 | 4 |
| ORL A, R7 | 4F | 1 | 3 | 12 | 4 |
| ORL A, @R0 | 46 | 1 | 6 | 12 | 2 |
| ORL A, @R1 | 47 | 1 | 6 | 12 | 2 |
| ORL A, direct | 45 | 2 | 6 | 12 | 2 |
| ORL A, #data | 44 | 2 | 12 | 24 | 2 |
| ORL direct, A | 42 | 2 | 12 | 24 | 2 |
| ORL direct, #data | 43 | 3 | 12 | 24 | 2 |
| ORL C, bit | 72 | 2 | 12 | 24 | 2 |
| ORL C, /bit | A0 | 2 | 12 | 24 | 2 |
| PUSH direct | C0 | 2 | 12 | 24 | 2 |
| POP direct | D0 | 2 | 12 | 24 | 2 |
| RET | 22 | 1 | 12 | 24 | 2 |
| RETI | 32 | 1 | 12 | 24 | 2 |
| RL A | 23 | 1 | 3 | 12 | 4 |
| RLC A | 33 | 1 | 3 | 12 | 4 |
| RR A | 03 | 1 | 3 | 12 | 4 |
| RRC A | 13 | 1 | 3 | 12 | 4 |
| SETB C | D3 | 1 | 3 | 12 | 4 |
| SETB bit | D2 | 2 | 6 | 12 | 2 |
| SWAP A | C4 | 1 | 3 | 12 | 4 |
| SJMP rel | 80 | 2 | 12 | 24 | 2 |
| SUBB A, R0 | 98 | 1 | 3 | 12 | 4 |
| SUBB A, R1 | 99 | 1 | 3 | 12 | 4 |
| SUBB A, R2 | 9A | 1 | 3 | 12 | 4 |
| SUBB A, R3 | 9B | 1 | 3 | 12 | 4 |
| SUBB A, R4 | 9C | 1 | 3 | 12 | 4 |
| SUBB A, R5 | 9D | 1 | 3 | 12 | 4 |
| SUBB A, R6 | 9E | 1 | 3 | 12 | 4 |
| SUBB A, R7 | 9F | 1 | 3 | 12 | 4 |
| SUBB A, @R0 | 96 | 1 | 6 | 12 | 2 |
| SUBB A, @R1 | 97 | 1 | 6 | 12 | 2 |
| SUBB A, direct | 95 | 2 | 6 | 12 | 2 |
| SUBB A, #data | 94 | 2 | 6 | 12 | 2 |
| XCH A, R0 | C8 | 1 | 3 | 12 | 4 |
| XCH A, R1 | C9 | 1 | 3 | 12 | 4 |
| XCH A, R2 | CA | 1 | 3 | 12 | 4 |
| XCH A, R3 | CB | 1 | 3 | 12 | 4 |
| XCH A, R4 | CC | 1 | 3 | 12 | 4 |
| XCH A, R5 | CD | 1 | 3 | 12 | 4 |
| XCH A, R6 | CE | 1 | 3 | 12 | 4 |
| XCH A, R7 | CF | 1 | 3 | 12 | 4 |
| XCH A, @R0 | C6 | 1 | 6 | 12 | 2 |
| XCH A, @R1 | C7 | 1 | 6 | 12 | 2 |
| XCHD A, @R0 | D6 | 1 | 6 | 12 | 2 |
| XCHD A, @R1 | D7 | 1 | 6 | 12 | 2 |
| XCH A, direct | C5 | 2 | 6 | 12 | 2 |
| XRL A, R0 | 68 | 1 | 3 | 12 | 4 |
| XRL A, R1 | 69 | 1 | 3 | 12 | 4 |
| XRL A, R2 | 6A | 1 | 3 | 12 | 4 |
| XRL A, R3 | 6B | 1 | 3 | 12 | 4 |
| XRL A, R4 | 6C | 1 | 3 | 12 | 4 |
| XRL A, R5 | 6D | 1 | 3 | 12 | 4 |
| XRL A, R6 | 6E | 1 | 3 | 12 | 4 |
| XRL A, R7 | 6F | 1 | 3 | 12 | 4 |
| XRL A, @R0 | 66 | 1 | 6 | 12 | 2 |
| XRL A, @R1 | 67 | 1 | 6 | 12 | 2 |
| XRL A, direct | 65 | 2 | 6 | 12 | 2 |
| XRL A, #data | 64 | 2 | 6 | 12 | 2 |
| XRL direct, A | 62 | 2 | 6 | 12 | 2 |
| XRL direct, #data | 64 | 3 | 12 | 24 | 2 |
| Average Speed | | | | | 2.87 |
| Ratio | | | | | |

What is claimed is:

1. A high-speed single chip microcomputer compatible with an Intel 8-bits single chip microcomputer comprising the feature of: a machine cycle of said single chip microcomputer containing three state cycles, and the execution time of an instruction being equal to triple multiple of said state cycle.

2. The single chip microcomputer according to claim 1 wherein said Intel 8-bits single chip microcomputer belongs to MCS-51 series.

3. The single chip microcomputer according to claim 2 wherein said single chip microcomputer of MCS-51 series is 8051.

4. The single chip microcomputer according to claim 1 wherein the time length of said state cycle is equal to a clock cycle of CPU clock.

5. The single chip microcomputer according to claim 1 wherein said single chip microcomputer is embedded into a controller.
